(19) United States
(12) Patent Application Publication
(10) Pub. No.: US 2010/0242176 A1
(43) Pub. Date: Sep. 30, 2010

(54) Maternity Grip

(76) Inventors: David C. Newkirk, Lawrenceburg, IN (US); Richard H. Heimbrock, Cincinnati, OH (US)

Correspondence Address: HILL-ROM SERVICES, INC., Legal Dept., Mail Code K04, 1069 State Road 46 East, BATESVILLE, IN, 47006, US

(21) Appl. No.: 12/414,936

(22) Filed: Mar. 31, 2009

(51) Int. Cl. A61G 7/05; A61G 7/075

(52) U.S. Cl. 5/602; 5/425

(57) ABSTRACT

A person-support apparatus comprises a frame including a handle movably coupled with the frame. The handle is adapted to be gripped by a person supported on the frame. The handle includes an adjustment mechanism configured to adjust the length of the handle.

### BACKGROUND OF THE DISCLOSURE

This disclosure relates to person-support apparatuses. More particularly, but not exclusively, one illustrative embodiment relates to multi-functional labor bars coupled to hospital beds.

Person-support apparatuses, such as, birthing beds, can provide support for patients during medical procedures. In the case of birthing beds, the person-support apparatus can support a mother throughout the labor and delivery of a baby. During the process it can be important for the mother to assume a comfortable position while she contracts her muscles to assist in moving the baby down the birth canal. Birthing beds can include a handle on each side of the bed in a position where they can be gripped by the mother for support. While a variety of handles for birthing beds have been developed, there is still room for improvement. Thus, a need persists for further contributions in this area of technology.

### SUMMARY OF THE DISCLOSURE

One illustrative embodiment can include a post coupled with a frame that includes an adjustment mechanism configured to adjust the length of the post and is adapted to be gripped by a person on the frame. In another illustrative embodiment, a post coupled with an upper frame includes a controller configured to control a function of the person-support apparatus and/or a device in communication with the person-support apparatus. In yet another illustrative embodiment, a handle includes a first end movably coupled with a frame and a second end, with a rotational joint positioned between the first end and the second end configured to allow the second end to rotate with respect to the first end. In still another illustrative embodiment, a siderail includes a maternity grip integrated therein that is adapted to be gripped by a person positioned on the frame.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

Referring now to the illustrative examples in the drawings, wherein like numerals represent the same or similar elements throughout:

FIG. 1 illustrates a perspective view of a person-support apparatus according to one illustrative embodiment;

FIG. 2 illustrates a perspective view of the person-support apparatus of FIG. 1 with a length adjustable labor bar;

FIG. 3 illustrates a side view of the length adjustment mechanism of FIG. 2

FIG. 4 illustrates a side view of a person-support apparatus according to another illustrative embodiment with a labor bar having multiple pivot points;

FIG. 5 illustrates a perspective view of a person-support apparatus, of FIG. 4 with a person using the labor bar;

FIG. 6 illustrates a side view of a labor bar according to another illustrative embodiment having a length adjuster and multiple pivot points; and

FIG. 7 illustrates a perspective view of a person-support apparatus according to yet another illustrative embodiment with a labor bar siderail.

### DESCRIPTION OF SPECIFIC ILLUSTRATIVE EMBODIMENTS

One illustrative embodiment can include a post coupled with a frame that includes an adjustment mechanism configured to adjust the length of the post and is adapted to be gripped by a person on the frame. In another illustrative embodiment, a post coupled with an upper frame includes a controller configured to control a function of the person-support apparatus and/or a device in communication with the person-support apparatus. In yet another illustrative embodiment, a handle includes a first end movably coupled with a frame and a second end, with a rotational joint positioned between the first end and the second end configured to allow the second end to rotate with respect to the first end. In still another illustrative embodiment, a siderail includes a maternity grip integrated therein that is adapted to be gripped by a person positioned on the frame.

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated

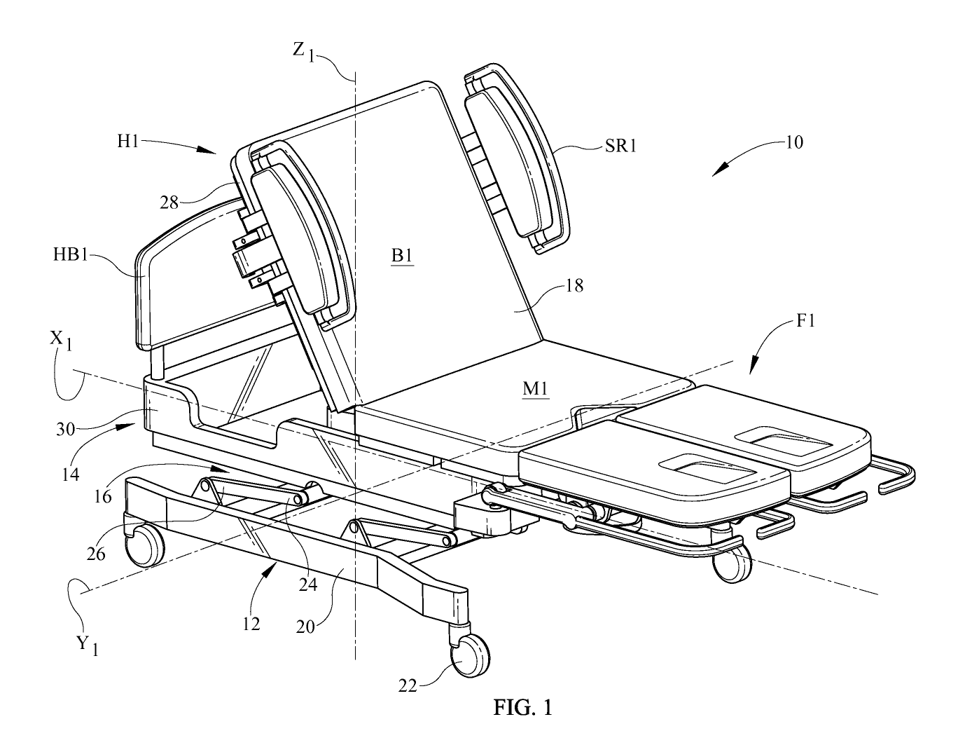

A person-support apparatus 10 according to one illustrative embodiment of the current disclosure is shown in FIG. 1. The person-support apparatus 10 can include a head section Hi, where the head of a person (not shown) is positioned, and a foot section F1, where the feet of a person (not shown) are positioned. The person-support apparatus 10 can include a lower frame 12 or base 12, an upper frame 14, and a plurality of supports 16 coupled with the upper frame 14 and the lower frame 12. It should be appreciated that the person-support apparatus 10 can include only one support 16.

The person-support apparatus 10 can support a person support surface 18 on the upper frame 14 as shown in FIG. 1. The person support surface 18 can be configured to support a person (not shown) in multiple articulated positions. The person support surface 18 can be formed of multiple sections that can include a back portion B1 and a main portion M1 (not shown). It should be appreciated that the person support surface 18 can be formed of a single section. The back portion B1 can be pivoted relative the upper frame portion 14 and the main portion M1 to raise and lower the head of the person supported thereon. The person support surface 18 can include one or more support sections having foam and/or air bladders that deliver therapy to the person through expansion/contraction, changes in pressure, and/or blowing air. For example, one or more sections of the person support surface 18 can provide alternating pressure therapy, continuous lateral rotation therapy, low air loss therapy, boost assistance, percussion/vibration therapy, and/or turn assistance.

The lower frame 12 can couple with the supports 16 to support the supports 16 and the upper frame 14 as shown in FIG. 1. The lower frame 12 can include multiple lower frame sections 20 supported by casters 22. It should be appreciated that the lower frame 12 can include a single lower frame section 20. It should also be appreciated that the lower frame 12 can not be supported by casters 22 and instead can be supported on a floor.

The supports 16 can define a vertical axis Z1 that extends through the lower frame 12 and the upper frame 14 and can be substantially perpendicular the lower frame 12 and the upper frame 14 as shown in FIG. 1. The supports 16 can be lift mechanisms 16 with a lift driver (not shown) that can cause the lift mechanisms 16 to expand and/or contract to raise and/or lower the upper frame 14 with respect to the lower frame 12. It should be appreciated that the supports 16 can be or can include at least one of telescoping towers, scissor lifts, rotational lifts, hydraulic lifts or actuators, pneumatic lifts or actuators, linear actuators, electronic actuators, chain lifts, or other lift mechanisms. It should also be appreciated that the supports 16 can not be lift mechanisms 16 and can instead be at least one fixed column (not shown). The supports 16 include an upper support portion 24 coupled with the upper frame 14 and a lower support portion 26 coupled with the lower frame 12.

The upper frame 14 can define a longitudinal axis X1 that extends at least the length of the person-support apparatus 10 through the head end H1 and the foot end F1 along the lateral center of the upper frame 14, and a lateral axis Y1 that can be perpendicular to the longitudinal axis X1 and extend at least the width of the person-support apparatus 10 through the longitudinal center of the upper frame 14 as shown in FIG. 1. The upper frame 14 can include a deck 28 that can be supported by an intermediate frame 30. It should be appreciated that the upper frame 14 can also include a footboard (not shown), a head board HB1, and/or side rails SR1 that can be supported by the intermediate frame 30. It should also be appreciated that the upper frame 14 can only include a deck 28. The deck 28 can be comprised of multiple sections that can articulate about the lateral axis 1i. It should be appreciated that the deck 28 can only include a single section that can articulate about the lateral axis Y1 or an axis parallel thereto. It should also be appreciated that the deck 28 can not articulate.

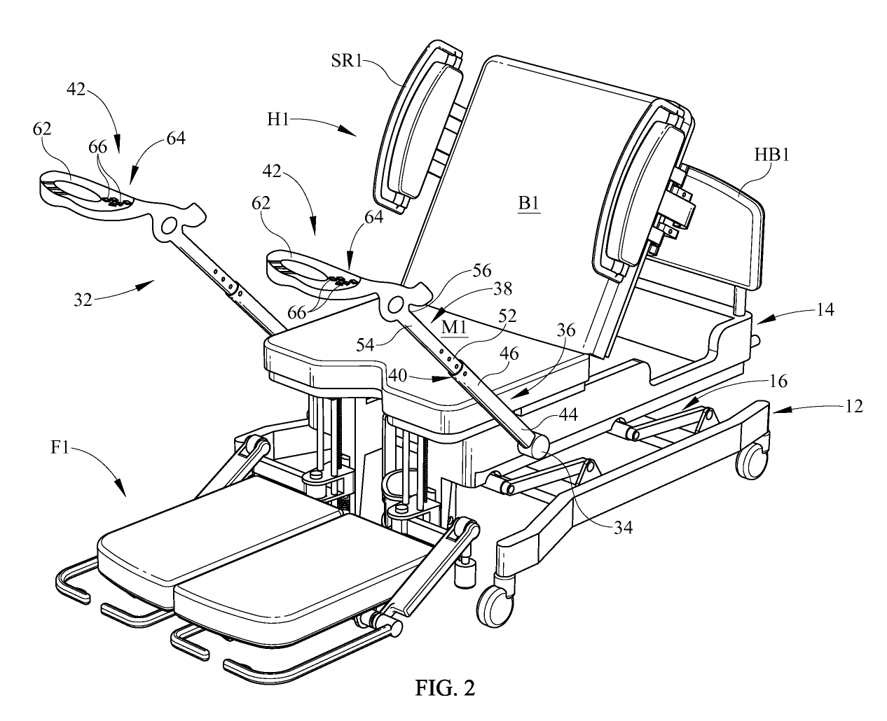

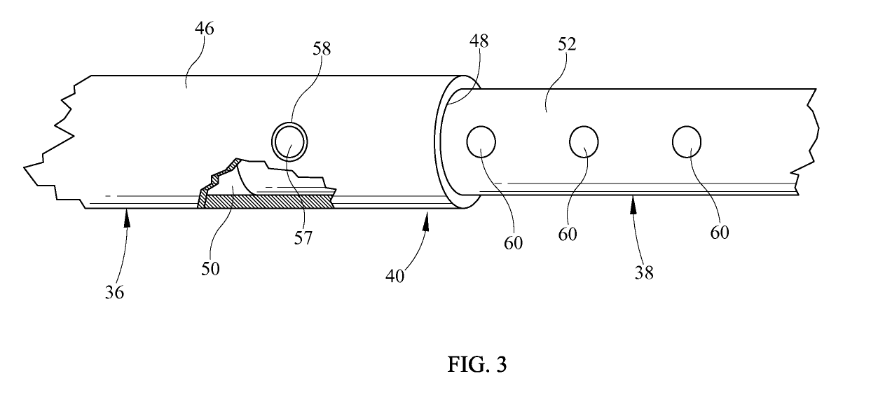

The upper frame 14 can include labor bars 32 or handles 32 according to one illustrative embodiment of the disclosure as shown in FIG. 2. It should be appreciated that the handles 32 can be movably coupled to the lower frame 12 or the supports 16. It should also be appreciated that the handles 32 can be fixedly coupled to the lower frame 12, upper frame 14, or the supports 16. The handles 32 can be pivotably coupled along the longitudinal sides of the upper frame 14 at first joints 34. The handles 32 can be moved between a storage position and a use position. In the storage position, the handles 32 can be rotated such that the handles 32 are positioned substantially under the upper frame 14; and in the use position, the handles 32 can be rotated so that is the handles 32 are positioned substantially above the person support surface 18 as shown in FIG. 3. It should be appreciated that the handles 32 can be rotated such that the handles 32 do not extend above the person support surface 18 in the storage position.

The handles 32 can include a first member 36, a second member 38, an adjustment mechanism 40, and a grip portion 42 as shown in FIG. 2. The first member 36 can be a tubular member 36 and can include a first lower end 44 and a first upper end 46. The first lower end 44 can be pivotably coupled to the upper frame 14 at the first joint 34. The first upper end 46 can include an opening 48 into an interior region 50 of the first member 36 as shown in FIG. 3.

The first joint 34 can be selectively locked and unlocked to prevent/allow pivoting of the handle 32 with respect to the upper frame 14 by utilizing remotely activated locking and pivoting joints as shown in FIG. 2. In one illustrative embodiment, the movable joints can be remotely actuated by a transmission device, such as, a cable, or pneumatically to allow selective locking/unlocking, in order to allow pivoting, and fixing, or locking of the movable joints to prevent pivoting. Such joints are available commercially from manufacturers, such as, Adjustable Locking Technologies, LLC under the trademark INFILOC and VARILOC. Other selectively lockable and pivotable joints are within the scope of this invention. One example can be a spline-type movable joint (not shown) in which the spline is meshed or engaged to lock the movable joint to prevent pivotal movement of the movable joint or not meshed, disengaged to allow pivotal movement of the movable joint. Another example can be a clutch-type movable joint (not shown) in which clutch friction pads are engaged to lock the movable joint to prevent movement of the movable joint or disengaged to allow pivotal movement of the movable joint.

The second member 38 can be movable with respect to the first member 36 as shown in FIGS. 2 and 3. The second member 38 can include a second lower end 52 and a second upper end 54 and can be a pole having a diameter of less than the diameter of the opening 48 into the interior region 50 of the first member 36. It should be appreciated that the second member 38 can be a cylinder with the interior region 50 and the first member 36 can be a pole having a diameter less than the diameter of the opening 48 into the interior region 50 of the second member 38. The second lower end 52 can be positioned within the interior region 50 of the first member 36 and can move within the interior region 50 toward the opening 48 or toward the first lower end 44 to adjust the length of the handle 32. The second upper end 54 can be coupled with the grip portion 42 at a second joint 56. It should be appreciated that the second joint 56 can be a selectively lockable/unlockable joint as previously described above with respect to the first joint 34.

The adjustment mechanism 40 can cooperate with the first upper end 46 of the first member 36 and the second lower end 52 of the second member 38 to maintain the desired length of the handle 32 as shown in FIGS. 2 and 3. The adjustment mechanism 40 can be a removable pin 56 that engages a first hole 58 in the first upper end 46 of the first member 36 and a plurality of second holes 60 in the second lower end 52 of the second member 38 as shown in FIG. 3. It should be appreciated that the adjustment mechanism 40 can be a cam lock, a spring loaded pin, a friction lock, or other locks used with telescoping arrangements. To adjust the length and/or orientation of the handle 32, the pin 56 can be removed from the first hole 58 and the second hole 60, which can allow the second lower end 52 of the second member 38 to slide within the interior region 50 of the first member 36 with respect to the first upper end 46 of the first member 36. To maintain the length and/or orientation of the handle 32, the pin 56 can be inserted into the first hole 58 and one of the second holes 60 to prevent movement of the first member 36 with respect to the second member 38. The handles 32 can be adjusted in height depending on the comfort of the person.

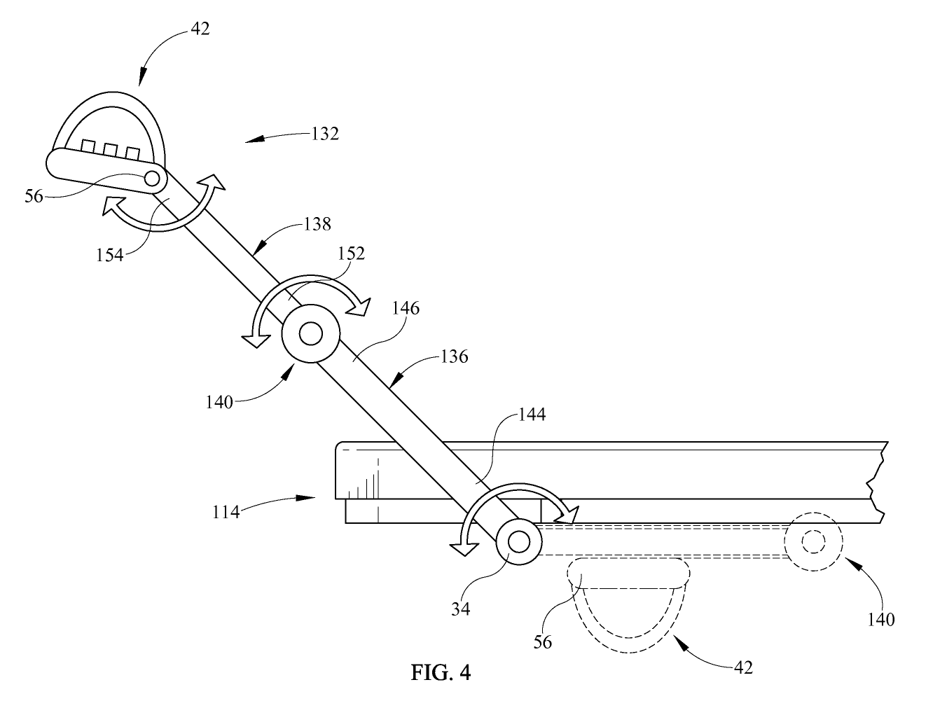

The grip portion 42 can include a grip 62 and a controller 64 as shown in FIG. 2. The grip 62 can be integrated into the second upper end 54 of the second member 38. It should be appreciated that the grip 62 can be coupled to the second upper end 54 of the second member 38 about a second joint 56 as shown in FIG. 4. A person supported on the upper frame 14 can hang on to the grip 62 for support. In one illustrative embodiment, the grip 62 can be hung on to by a person during the birthing process.

The controller 64 can be coupled to the grips 62 as shown in FIG. 2. It should be appreciated that the controller 64 can be detachable from the grip 62 and can be used from a remote location. It should also be appreciated that the controller 64 can be integrated into the grip 62. It should be further appreciated that the controller 64 can be coupled to or integrated into any portion of the handles 32. The controller 64 can include a plurality of buttons 66 electrically coupled with a control system (not shown) of the person-support apparatus 10 and can be configured to control at least one function of the person-support apparatus 10. It should be appreciated that the controller 64 can also include a rotational dial, touch screen, microphone, and/or other user interface. It should also be appreciated that the controller 64 can control the function of a device or system, such as, for example, a nurse call system, room/bed lighting, television, and/or windows/blinds, in communication with the person-support apparatus 10, whether the device or system communicates with the person-support apparatus via a wired, wireless, hospital network, or other connection.

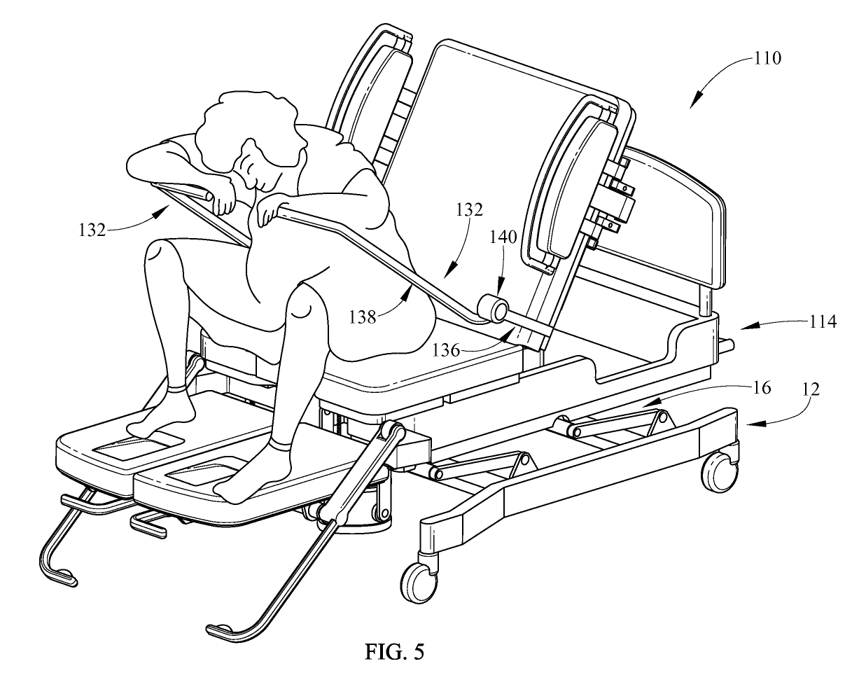

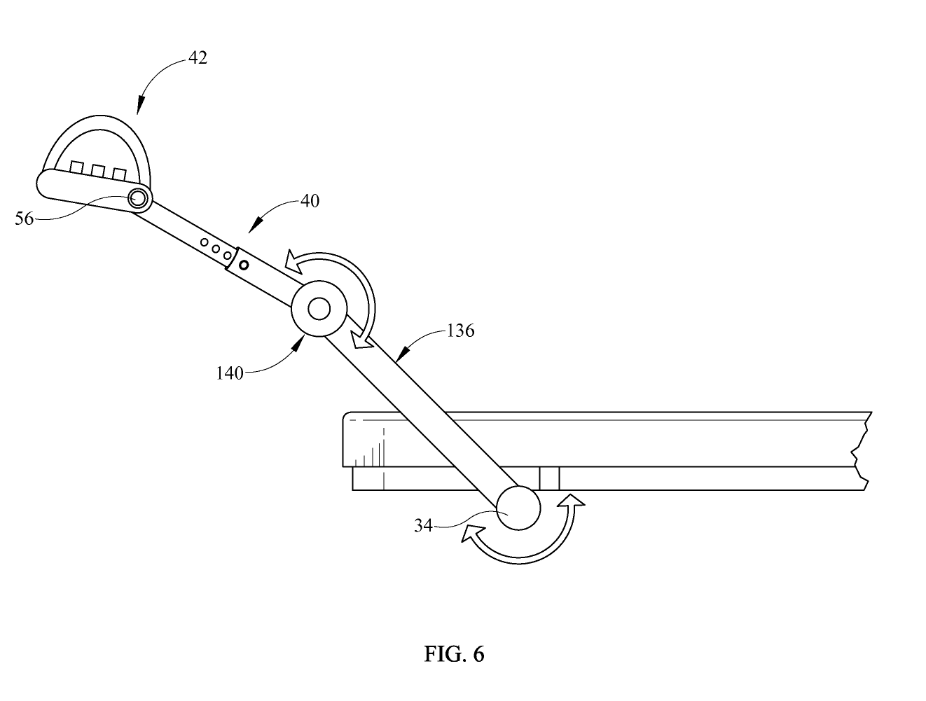

The person-support apparatus 110 according to another embodiment of the disclosure, wherein like numerals represent similar features as in the other embodiments, is illustrated in FIGS. 4 and 5. The person-support apparatus 10 can include a lower frame 12 or base 12, an upper frame 114, and a plurality of supports 16 coupled with the upper frame 114 and the lower frame 12. The upper frame 114 can include a handle 132 or labor bar 132 coupled thereto. The handle 132 can include a first member 136, a second member 138, a pivot joint 140, and a grip portion 42. It should be appreciated that the handle 132 can also include an adjustment mechanism 40 as described above and shown in FIG. 6.

The first member 136 can be a pole and can include a first lower end 144 and a first upper end 146 as shown in FIG. 4. The first lower end 144 can be pivotably coupled to the upper frame 114 at the first joint 34. The first upper end 146 can be coupled to the second member 138 at a pivot joint 140. The pivot joint 140 can be a selectively lockable/unlockable joint as previously described above with respect to the first joint 34.

The second member 138 can be a pole and can be pivotable with respect to the first member 136 to change the orientation of the handle 132 as shown in FIG. 4. The second member 138 can include a second lower end 152 and a second upper end 154. The second lower end 152 can be coupled to the first member 136 at the pivot joint 140. The second member 138. It should be appreciated that the first member 136 and/or the second member 138 can be rotated toward and away from the head portion H1 to accommodate the orientation and/or height preferences of the person supported on the person-support apparatus 110. It should also be appreciated that the handle 124 can be rotated such that the first member 136 and the second member 138 are substantially parallel one another, and then moved to a storage position below the upper frame 114. The second upper end 154 of the second member 138 can be coupled with the grip portion 42 at a second joint 56.

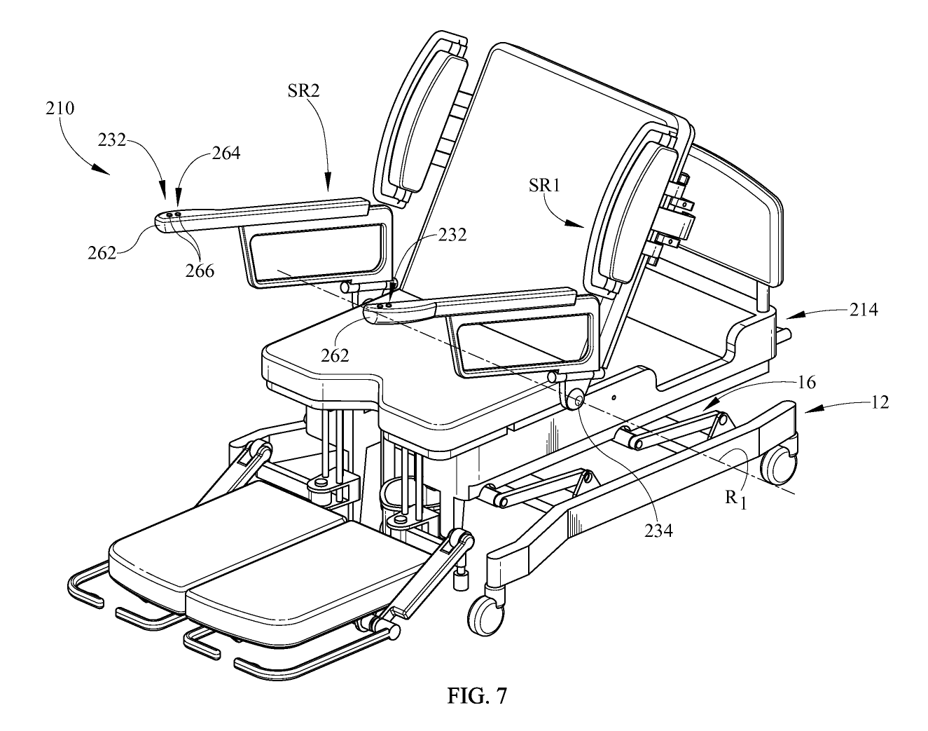

The person-support apparatus 210 according to another embodiment of the disclosure is illustrated in FIG. 7. The person-support apparatus 210 can include a lower frame 12 or base 12, an upper frame 214, and a plurality of supports 16 coupled with the upper frame 214 and the lower frame 12. The upper frame 214 can include siderails SR1 movably coupled thereto at first joints 234. It should be appreciated that the first joints 234 can be selectively lockable/unlockable joints as previously described above with respect to the first joint 34. The orientation of the siderails SR1 with respect to the upper frame 214 can be changed to a suitable orientation based on the preferences of the person supported on the person-support apparatus 210 by rotating the siderail SR1 about a rotational axis R1 passing through the first joint 234.

The siderail SR2 can include a handle 232 or labor bar 232 integrated therein as shown in FIG. 7. The handle 232 can include a grip 262 and a controller 264 coupled thereto. It should be appreciated that the controller 264 can be integrated into the siderail SR2 or detachable from the siderail SR2 and usable from a remote location. The grip 262 can be gripped by a person positioned on the person-support apparatus 210. In one illustrative embodiment, the grip 262 can be hung on to by a person during the birthing process. The controller 264 can include buttons 266 and be configured to control the function of a device or system, such as, for example, a nurse call system, room/bed lighting, television, and/or windows/blinds, in communication with the person-support apparatus 210, whether the device or system communicates with the person-support apparatus via a wired, wireless, hospital network, or other connection. It should be appreciated that the controller 264 can be constructed and/or operate similarly to the controller 64 previously described above.

Many other embodiments of the present disclosure are also envisioned. For example, a person-support apparatus comprises a frame including a handle movably coupled with the frame. The handle is adapted to be gripped by a person supported on the frame. The handle includes an adjustment mechanism configured to adjust the length of the handle.

In another example, a person-support apparatus comprises a lower frame, a plurality of supports and an upper frame. The upper frame is supported by the plurality of supports above the lower frame. At least one of the upper frame and lower frame includes a handle movably coupled with at least one of the lower and the upper frame. The handle is adapted to be gripped by a person positioned on the upper frame. The handle includes a controller configured to control a function of the person-support apparatus.

In yet another example, a person support comprises a frame and a handle. The handle has a first member movably coupled with the frame and a second member. The handle is adapted to be gripped by a person supported on the frame. The handle includes a rotational joint positioned between the first member and the second member and configured to allow the second member to rotate with respect to the first member.

In yet another example, a person-support apparatus comprises a frame and a siderail. The frame has a pair of lateral sides. The siderail is positioned along at least one of the lateral sides. The siderail includes a maternity grip integrated therein. The maternity grip is adapted to be gripped by a person supported on the frame.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

1. A handle, comprising:
a first member with a first portion and a second portion, the first portion being movably coupled to a person-support apparatus; and
a second member with a first portion and a second portion, the first portion being movably coupled to the second portion of the first member such that the second member is movable with at least two degrees of freedom with respect to the person-support apparatus.

2. The handle of claim 5, wherein at least one of the first member and the second member includes an adjustment mechanism configured to adjust the length of the handle.

3. The handle of claim 1 further comprising a controller configured to control a function of at least one of the person-support apparatus, a device in communication with the person-support apparatus, and a system in communication with the person-support apparatus.

4. (canceled)

5. The handle of claim 1, wherein the first member is movably coupled to the person-support apparatus at a first rotatable joint and the second member is movably coupled to the first member at a second rotatable joint.

6. The handle of claim 5, wherein at least one of the first rotatable joint and the second rotatable joint is lockable.

7. A handle, comprising:
a first member including a first portion and a second portion, the first portion being movably coupled to a person-support apparatus by a rotatable joint; and
a second member including a first portion movably coupled to the second portion of the first member, the second member being movable with respect to the first member independent of the movement of the first member with respect to the person-support apparatus.

8-9. (canceled)

10. The handle of claim 7, wherein the first portion of the second member is movably coupled to the second portion of the first member by a length adjustment mechanism configured to adjust the length of the handle.

11. The handle of claim 7, wherein the first portion of the second member is movably coupled to the second portion of the first member by a second rotatable joint.

12. The handle of claim 11, wherein at least one of the rotatable joints is lockable.

13-14. (canceled)

15. A handle, comprising:
a first member including a first portion and a second portion, the first portion being movably coupled to a person-support apparatus;
a rotatable joint coupled to the second portion of the first member; and
a second member including a first portion and a second portion, a portion of the second member being coupled to the rotatable joint, the second member being rotatable about the rotatable joint with respect to the first member independent of the movement of the first member with respect to the person-support apparatus.

16. The handle of claim 36, wherein at least one of the rotatable joint is lockable.

17. The handle of claim 15, wherein at least one of the first member and the second member includes a height adjustment portion, the height adjustment portion adjusting the length of the one of the first member and the second member.

18. The handle of claim 15 further comprising a controller configured to control a function of at least one of the person-support apparatus, a device in communication with the person-support apparatus, and a system in communication with the person-support apparatus.

19. The handle of claim 3, wherein the controller removable from the handle and remotely operable.

20. The handle of claim 1, wherein the handle is movable between a storage position and a use position, where a portion of the handle is positioned above a portion of a person support surface supported on the person-support apparatus in the use position.

21. A person-support apparatus, comprising:
a frame including a head section and a foot section; and
at least one siderail movably coupled to the frame at a pivot; and
a maternity grip integrated into the siderail, the maternity grip including a grip portion with a grip and a controller, wherein the controller is integrated into the grip and configured to be operated by a person while the person is gripping the grip.

22. The person-support apparatus of claim 21, wherein the controller is configured to control a function of at least one of the person-support apparatus, a device in communication with the person support apparatus, and a system in communication with the person-support apparatus.

23-24. (canceled)

25. The person-support apparatus of claim 21, wherein the siderail moves with the head section of the frame as the head section moves with respect to the foot section.

26. The handle of claim 1, wherein the first member is movably coupled to the person-support apparatus by one of a length adjustment mechanism and a rotatable joint, and the second member is movably coupled to the first member by one of a length adjustment mechanism and a rotatable joint.

27. The handle of claim 1 further comprising a grip movably coupled to the second portion of the second member, the grip being configured to move with three degrees of freedom with respect to the person-support apparatus.

28. The handle of claim 1, wherein the handle moves with at least one degree of rotational freedom and at least one degree of translational freedom.

29. The handle of claim 7 further comprising a grip movably coupled to the second portion of the second member, the grip being configured to move with three degrees of freedom with respect to the person-support apparatus.

30. The handle of claim 7 further comprising a controller configured to control a function of at least one of the person-support apparatus, a device in communication with the person-support apparatus, and a system in communication with the person-support apparatus.

31. The handle of claim 15, wherein the first portion of the first member is movably coupled to the person-support apparatus by at least one of a rotatable joint and a length adjustment mechanism.

32. The handle of claim 15 further comprising a grip movably coupled to the second portion of the second member, the grip being configured to move with three degrees of freedom with respect to the person-support apparatus.

33. A person-support apparatus, comprising:
a frame including a head section and a foot section; and
a siderail movably coupled to the frame at a pivot, the siderail including a body and a perimeter edge, a portion of the perimeter edge defining a grip; and
a user interface integrated into the surface of the grip.

34. The person-support apparatus of claim 33, wherein the user interface includes a plurality of buttons.

35. The person-support apparatus of claim 34, wherein the buttons are recessed into the surface of the grip.

36. The person-support apparatus of claim 33, wherein the user interface is configured to control a function of at least one of the person-support apparatus, a device in communication with the person support apparatus, and a system in communication with the person-support apparatus.

37. A person-support apparatus, comprising:
a frame including a head section and a foot section; and
a siderail including a siderail body with perimeter edge, the siderail body including a first portion and a second portion, the first portion having an opening therethrough that cooperates with the perimeter edge to define a first grip, the second portion extends from the first portion and defines a second grip, the first grip being configured to assist a person supported on the frame with at least one of ingress and egress to/from the frame, the second grip being configured to provide support to a person during a birthing process.

38. The person-support apparatus of claim 37, wherein the second portion extends from the first grip.

39. The person-support apparatus of claim 37 further comprising a user interface coupled to the second grip.

40. The person-support apparatus of claim 39, wherein the user interface is integrated into a surface of the second grip.

41. The person-support apparatus of claim 37, wherein the user interface includes a plurality of buttons.

42. The person-support apparatus of claim 37, wherein the user interface is configured to control a function of at least one of the person-support apparatus, a device in communication with the person support apparatus, and a system in communication with the person-support apparatus.
